(19) United States
(12) Patent Application Publication
(10) Pub. No.: US 2019/0178264 A1
(43) Pub. Date: Jun. 13, 2019

(54) VEHICLE CONTROL DEVICE

(71) Applicant: HONDA MOTOR CO., LTD., Tokyo (JP)

(72) Inventor: Yuma Yoshida, Wako-shi (JP)

(73) Assignee: HONDA MOTOR CO., LTD., Tokyo (JP)

(21) Appl. No.: 16/323,420

(22) PCT Filed: Jul. 25, 2017
(86) PCT No.: PCT/JP2017/026824

§ 371 Date: Feb. 5, 2019

(30) Foreign Application Priority Data
Aug. 10, 2016 (JP) 2016-157727

(51) Int. Cl. F15B 11/00; F15B 13/02; F15B 11/10

(52) U.S. Cl. CPC F15B 11/003; F16D 25/0638; F15B 11/10; F15B 13/024

(57) ABSTRACT

Accurate control is to be performed while taking an advantage of the hydraulic pressure sealing-type control. A control device of a vehicle includes a hydraulic chamber (15) into which a hydraulic pressure operating a power transmission element (10) is introduced, a first pressure regulating mechanism (35, 37) and a second pressure regulating mechanism (43) that switch hydraulic pressure in the hydraulic chamber (15), and a control device (50). The control device (50) can switch a first state in which the pressure regulating mechanism (35, 37) is in a pressure rising state and the second pressure regulating mechanism (43) is in a holding state so as to increase pressure of the hydraulic chamber, and a second state in which the second pressure regulating mechanism (43) is in a non-holding state so as to decompress the hydraulic chamber.

### TECHNICAL FIELD

The present invention relates to a vehicle control device for controlling clutch pressure in a vehicle including a hydraulic pressure sealing-type clutch provided in a power transmission path.

### BACKGROUND ART

Conventionally, a hydraulic pressure sealing-type four wheel drive system is known as an electronically controlled four wheel drive system that alternately switches a two wheel drive (2WD) state and a four wheel drive (4WD) state. In this drive system, a front-rear torque distribution clutch is provided midway on a propeller shaft connecting a front differential mechanism and a rear differential system to each other. And, by supplying hydraulic pressure (oil) driving the clutch via a check valve using an electric oil pump and then sealing the supplied hydraulic pressure using a solenoid valve, the clutch is kept engaged. For instance, refer to Patent Document 1.

Moreover, after a predetermined hydraulic pressure (namely, a clutch pressure) is sealed in the clutch, engagement of the clutch, or in other words, a thrusting force of the clutch, namely, distribution of torque transmitted to front and rear wheels can be changed by controlling opening and closing of the solenoid valve provided between the clutch and the check valve. Therefore, after the vehicle transfers to the four wheel drive state, the engagement of the hydraulic clutch (namely, the thrusting force of the clutch) is maintained as long as the solenoid valve is closed. Thus, the four wheel drive state can continue without continuing to operate a motor of the electric oil pump. This is an advantage of the hydraulic pressure sealing-type four wheel drive system from the view point of reduction of operation frequency and conservation electric energy of the motor.

However, only the opening and closing control of the solenoid valve (namely, sealing control) has enabled no accurate control of the distribution of the torque transmitted to the front and rear wheels. This is because in the sealing control, an overshoot may occur to an actual hydraulic pressure when operating the electric oil pump at the time of changing a designated hydraulic pressure, which makes it difficult to maintain the accuracy of torque control.

### RELATED ART DOCUMENTS

### Patent Documents

[Patent Document 1] Japanese Unexamined Patent Application Publication No. 2013-067326

### DISCLOSURE OF THE INVENTION

### Problem to Be Solved by the Invention

The present invention was made in view of the above-mentioned point, and the purpose is to ensure accuracy of control, while taking an advantage of the hydraulic pressure sealing-type control.

### Means of Solving the Problems

In order to solve the above-described problems, a vehicle control device in accordance with the present invention includes a power transmission system, a first pressure regulating mechanism (35, 37), a second pressure regulating mechanism (43) and a control device (50). The power transmission system has a power transmission element (10) and a hydraulic chamber (15) into which a hydraulic pressure that operates the power transmission element (10) is introduced, and is arranged in a power transmission path (20) that transmits power from a power source (3) to driving wheels (W3, W4). The first pressure regulating mechanism (35, 37) switches a pressure rising state and non-pressure rising state of the hydraulic pressure in the hydraulic chamber (15). The second pressure regulating mechanism (43) switches a holding state and a non-holding state of the hydraulic pressure in the hydraulic chamber (15). The control device (50) controls the first pressure regulating mechanism (35, 37) and the second pressure regulating mechanism (43) so that an actual hydraulic pressure in the hydraulic chamber (15) reaches a target hydraulic pressure. The control device (50) can switch a first state in which the fist pressure regulating mechanism (35, 37) is in the pressure rising state and the second pressure regulating mechanism (43) is in the holding state to increase the pressure of the above-described hydraulic chamber and a second state in which the second pressure regulating mechanism (43) is in the non-holding state to decompress the above-described hydraulic chamber. And, the control device (50) performs state switching control that switches the first state to the second state when the actual hydraulic pressure exceeds the target hydraulic pressure.

In this manner, if the actual hydraulic pressure exceeds the target hydraulic pressure when the hydraulic chamber (15) is in the first state, the control device (50) performs the state switching control that switches the first state to the second state. Since the hydraulic chamber (15) is decompressed during the sealing control in the second state, the actual hydraulic pressure can be prevented from largely exceeding the target hydraulic pressure (also referred to as “overshooting”). This enables accurate control while taking an advantage of the hydraulic pressure sealing-type control.

Furthermore, in the above-described vehicle control device, the control device (50) may characteristically perform the state switching control when the actual hydraulic pressure fulfills a predetermined condition beyond the target hydraulic pressure. For example, the predetermined condition may be a predetermined duration time for which, or longer than which, the actual hydraulic pressure is beyond the target hydraulic pressure. This can avoid an excessive frequency of the state switching control when the actual hydraulic pressure frequently exceeds and falls below the target hydraulic pressure, and thus ensures stability and accuracy of control.

Moreover, in the above-described vehicle control device, when performing the state switching control, the control device (50) may characteristically switch the first pressure regulating mechanism (35, 37) to the above-described non-pressure rising state before switching the second pressure regulating mechanism (43) to the above-described non-holding state. In this manner, by switching the first pressure regulating mechanism (35, 37) to the non-pressure rising state before switching the second pressure regulating mechanism (43), a pressure rising factor can be removed before decompression, which enables reduction overshoot. In addition, the switching of the first pressure regulating mechanism and the switching of the second pressure regulating mechanism at different timings enables clear and accordingly accurate control.

Furthermore, in the above-described vehicle control device, the control device (50) may perform the state switching control only once every time when the target hydraulic pressure rises by a predetermined amount. This state switching control decompresses the hydraulic chamber (15). Thus, an excessive reduction in hydraulic pressure of the piston chamber (15) in which the hydraulic pressure is sealed can be prevented by limiting the number of times of this state switching control.

Also in the above-described vehicle control device, if the actual hydraulic pressure falls below the target, hydraulic pressure after performing the state switching control due to the actual hydraulic pressure beyond the target hydraulic pressure, the control device (50) may perform state second-time switching control that switches the second state to the first state. In this manner, by performing the state second-time switching control when the actual hydraulic pressure again reaches the target hydraulic pressure, a next increase in the target hydraulic pressure can be immediately coped with.

It should be noted that the bracketed reference numerals are examples of the elements of the embodiment described later.

### EFFECTS OF THE INVENTION

The vehicle control device in accordance with the present invention can perform accurate control while taking an advantage of the hydraulic pressure sealing-type control.

### BRIEF DESCRIPTION OF DRAWINGS

FIG. 1 is a schematic view illustrating a vehicle including a vehicle control device according to the present embodiment;

FIG. 2 is a view illustrating a detailed configuration of a hydraulic pressure sealing-type hydraulic circuit;

FIG. 3 is a block diagram illustrating a configuration of a 4WD-ECU;

FIG. 4 is a time chart of states before and after a general sealing control using a solenoid valve and a motor;

FIG. 5 is a flow chart describing a solenoid valve opening control when regulating pressure during a sealing control in the present embodiment; and

FIG. 6 is a time chart describing states before and after a general sealing control using a solenoid valve and a motor according to the present embodiment.

### MODE FOR CARRYING OUT THE INVENTION

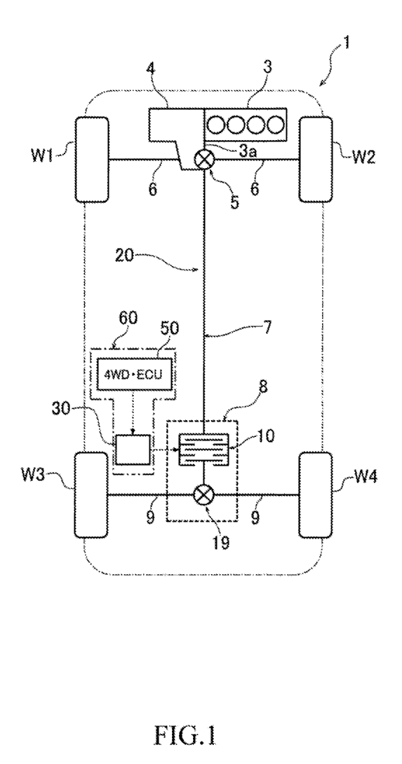

Embodiments of the present invention will be described as below with reference to the accompanying drawings. FIG. 1 is a schematic view illustrating a vehicle including a vehicle control device according to the present embodiment. The vehicle 1 shown in the figure is a four-wheel-drive vehicle including an engine 3 (namely, a power source) installed laterally at a front part of the vehicle 3, an automatic transmission 4 provided integrally with the engine 3, and a power transmission path 20 for transmitting power from the engine 3 to front wheels W1, W2 and rear wheels W3, W4.

An output shaft (not shown in the figure) of the engine 3 is connected, via the automatic transmission 4, a front differential 5 and right and left front drive shafts 6, to the right and left front wheels W1, W2 that serve as main driving wheels. Further, the output shaft of the engine 3 is connected, via the automatic transmission 4, the front differential 5, a propeller shaft 7, a rear differential unit 8 and right and left rear drive shafts, to the right and left rear wheels W3, W4 that serve as auxiliary driving wheels.

The rear differential unit 8 is provided with a rear differential 19 for distributing power to the left and right rear drive shafts 9 and a power transmission clutch (namely, a power transmission element) 10 for connecting and disconnecting the power transmission path 20 from the propeller shaft 7 to the rear differential 21.

The power transmission clutch 10, as will be described below, is a hydraulic pressure-type clutch that operates by introducing a hydraulic pressure from the piston chamber (namely, hydraulic chamber) 15. The power transmission clutch 10 and the piston chamber 15 constitute a power transmission system. And, the power transmission system is arranged in the power transmission path 20, having an effect of power distribution for controlling power distributed to the rear wheels W3, W4. The power transmission system also includes a hydraulic circuit 30 for supplying hydraulic fluid to the power transmission clutch 10 and an ECU 50 (namely, 4WD-ECU) that is a control device for controlling a hydraulic pressure supplied by the hydraulic circuit 30. The ECU 50 includes a microcomputer and other devices.

The ECU 50 controls the power distributed to the rear wheels W3, W4 using the power transmission clutch 10 by controlling the hydraulic pressure supplied by the hydraulic circuit 30. Thus, the drive control is performed with the front wheels W1, W2 and the rear wheels W3, W4 that serve respectively as the main driving wheels and the auxiliary driving wheels.

That is to say, on one hand, when the power transmission clutch 10 is released (namely, disengaged), no rotation of the propeller shaft 7 is transmitted to the rear differential 19 side. And, whole torque of the engine 3 is transmitted to the front wheels, W1, W2, thereby establishing the front-wheel drive (2WD). On the other hand, when the power transmission clutch 10 is in engagement, the rotation of the propeller shaft 7 is transmitted to the rear differential 19 side. Consequently, the torque of the engine 3 is distributed to both the front wheels W1, W2 and the rear wheels W3, W4, thereby establishing the four-wheel drive (4WD).

Based on results detected by various detection means (not shown in the figure) for detecting running conditions of the vehicle, the ECU 50 calculates power distributed to the rear wheels W3, W4 and an amount of corresponding hydraulic pressure supplied to the power transmission clutch 10 and thus outputs a drive signal based on the calculated results to the power transmission clutch 10. This allows to control an engaging force of the clutch 10 and thus control the power distributed to the rear wheels W3, W4.

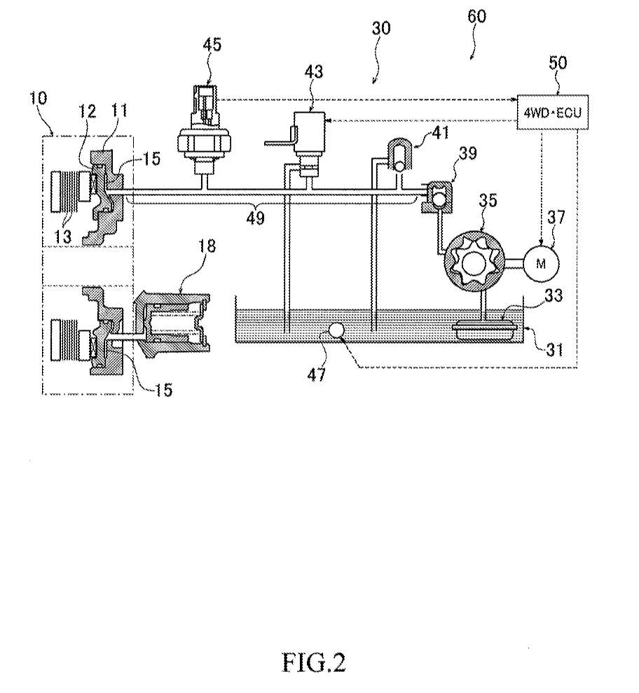

FIG. 2 is a view illustrating a detailed configuration of the hydraulic pressure sealing-type hydraulic circuit 30. The hydraulic circuit 30 shown in the figure includes an oil pump 35, a motor 37 and an oil passage 40. The oil pump 35 pumps up and forcibly feeds hydraulic fluid stored in the oil tank 31 via an oil strainer 33. The motor 37 drives the oil pump 35. The oil passage 40 communicates from the oil pump 35 to the piston chamber 15 of the power transmission clutch 10.

The power transmission clutch 10 includes a cylinder housing 11 and a piston 12 that advances and retreats in the cylinder housing 11 to press a plurality of laminated friction materials 13. In the cylinder housing 11, the piston chamber 15 is defined so that hydraulic fluid is introduced between the piston chamber 15 and the piston 12. The piston 12 is arranged opposite to one end in the lamination direction of the plurality of friction materials 13. Thus, the piston 12 presses the friction materials 13 in the lamination direction by the force of hydraulic pressure of the hydraulic fluid supplied to the piston chamber 15. This allows the power transmission clutch 10 to engage at a predetermined engagement pressure.

In the oil passage 40 communicating from the oil pump 35 to the piston chamber 15, a check valve 39, a relief valve 41, a solenoid valve (namely, an opening and closing valve) 43 and a hydraulic pressure sensor 45 are installed in this order. The check valve 39 is configured to circulate hydraulic fluid from the oil pump 35 side toward the piston chamber 15 side, but to prevent the hydraulic fluid from circulating in the reverse direction. Thus, the hydraulic fluid pumped by driving the oil pump 35 to the downstream side of the check valve 39 can be sealed in the oil passage 49 between the check valve 39 and the piston chamber 15. Hereinafter, the oil passage 49 may be referred to as “sealing oil passage.”

In this embodiment, on one hand, the oil pump 35 and the motor 37 (namely, the first pressure regulating mechanism) for switching the pressure rising state and the non-pressure rising state of hydraulic pressure perform pressurization when the piston chamber 15 is sealed by the check valve 39. On the other hand, pressure holding or decompression when the piston chamber 15 is sealed is performed using the solenoid valve 43 (namely, the second pressure regulating mechanism) that switches the holding state and non-holding state of the hydraulic pressure.

The oil passage 49 provided with the check valve 39 and the oil pump 35 as described above constitutes the hydraulic pressure sealing-type hydraulic circuit 30. In the present embodiment, the check valve 39 is a hydraulic fluid sealing valve for sealing hydraulic fluid in the oil passage 49 communicating from the oil pump 35 to the piston chamber 15.

The relief valve 41 is configured to open when the pressure of the oil passage 49 between the check valve 39 and the piston chamber 15 abnormally rises beyond a predetermined threshold value, so as to release the hydraulic pressure of the oil passage 49. The hydraulic fluid discharged from the relief valve 41 returns to the oil tank 31.

The solenoid valve 43 is an on-off type valve that is PWM-controlled (namely, duty-controlled) on the basis of a command from the ECU 50, thereby enabling the opening and closing control of the oil passage 49 and thus the control of the hydraulic pressure of the piston chamber 15.

It should be noted that the hydraulic fluid discharged from the oil passage 49 by opening the solenoid valve 43 returns to the oil tank 31. The hydraulic pressure sensor 45 is a hydraulic pressure detection means for detecting the hydraulic pressure of the oil passage 49 and the piston chamber 15. Values detected by the hydraulic pressure sensor 45 are sent to ECU 50. In the oil tank 31, a hydraulic fluid temperature sensor 47 is provided for detecting temperature of hydraulic fluid. Values detected by the hydraulic fluid temperature sensor 47 are sent to the ECU 50.

In the hydraulic pressure control of this embodiment, the above-described configuration has at least three driving states that are specifically three states of hydraulic pressure applied to the piston chamber 15 by the hydraulic circuit 30. Specifically, a first state is one in which the solenoid valve 43 is closed to drive the oil pump 35 and thus raise the hydraulic pressure of the oil passage 49 (namely, the hydraulic pressure of the piston chamber 15). A second state is one in which the oil passage 49 is decompressed by stopping driving the oil pump 35 and opening the solenoid valve 43. And, a third state is one in which the solenoid valve 43 is opened to drive the oil pump 35. The first state and the second state are sealing control, and the third state is flow control (namely, non-sealing control). Which state of these is applied is determined according to the ECU 50 control.

The ECU 50 calculates estimated power depending on a torque of the engine 3 and a gear ratio of the automatic transmission 4, then calculates a command torque of the power transmission clutch 10 on the basis of this estimated power and a vehicle running condition, and then calculates a target hydraulic pressure of the piston chamber 15 of the power transmission clutch 10 depending on the command torque. Then, the ECU 50 performs control so that an actual hydraulic pressure of the piston chamber 15 reaches the target hydraulic pressure.

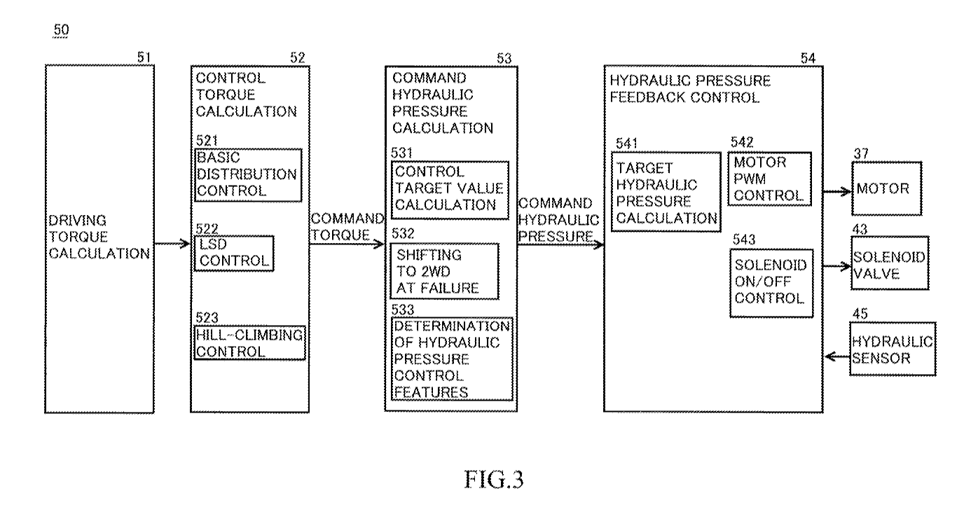

FIG. 3 is a block diagram showing a configuration of the 4WD-ECU 50. A driving torque calculation block 51 calculates a driving torque required for the vehicle 1 depending on a running condition of the vehicle 1 (such as torque of the engine 3, a selected gear step and a shift position).

In a control torque calculation block 52, a basic distribution control block 521 (performing basic control of the power distributed to the front and rear wheels W1-W4), an LSD control block 522, a hill-climbing control block 523, etc. determine distribution of the driving torque transmitted to the front and rear wheels depending on various kinds of control factors so as to calculate the command torque of the power transmission clutch 10.

A command hydraulic pressure calculation block 53 calculates a command hydraulic pressure for the power transmission clutch 10 according to the command torque. That is to say, a control target value calculation block 531 calculates a control target value for the power transmission clutch 10 according to the command torque. And, a block for shifting to 2WD at failure 532 calculates a control target value for shifting to 2WD at failure. At a normal time, on one hand, the control target value calculated by the control target value calculation block 531 is output as a command hydraulic pressure. At failure, on the other hand, the control target value calculated by the block for shifting to 2WD at failure 532 is output as a command hydraulic pressure.

In a hydraulic pressure feedback control block 54, a target hydraulic pressure calculation block 541 calculates a target hydraulic pressure of the power transmission clutch 10 according to a deviation (namely, a hydraulic pressure deviation) between the above-mentioned command hydraulic pressure given from the above-described hydraulic pressure calculation block 53 and an actual hydraulic pressure (namely, a feedback signal from the hydraulic pressure sensor 45), so as to control the motor 37 or the solenoid valve 43 according to this calculated target hydraulic pressure.

In the hydraulic pressure feedback control block 54, a motor PWM control block 542 generates a PWM driving command signal for the motor 37 depending on the target hydraulic pressure. Further, a solenoid ON/OFF control block 543 generates an ON (closing)/OFF (opening) indication signal for the solenoid valve 43 according to a hydraulic pressure deviation between the above-mentioned command hydraulic pressure and a feedback signal (namely, an actual hydraulic pressure) from the hydraulic pressure sensor 45 and the target hydraulic pressure.

It should be noted that the command hydraulic pressure calculation block 53 includes a hydraulic pressure control state determination block 533. This block determines in which of the above-described first to third states the control should be performed, according to the above-mentioned command torque (namely, demand torque) given from the control torque calculation block 52, and thus generates a hydraulic pressure control state indication signal that specifies the determined state. This hydraulic pressure control state indication signal is given to the hydraulic pressure feedback control block 54. Then, according to this determined hydraulic pressure control state, the target hydraulic pressure calculation block 541, the motor PWM control block 542 and the solenoid ON/OFF control block 543 operate.

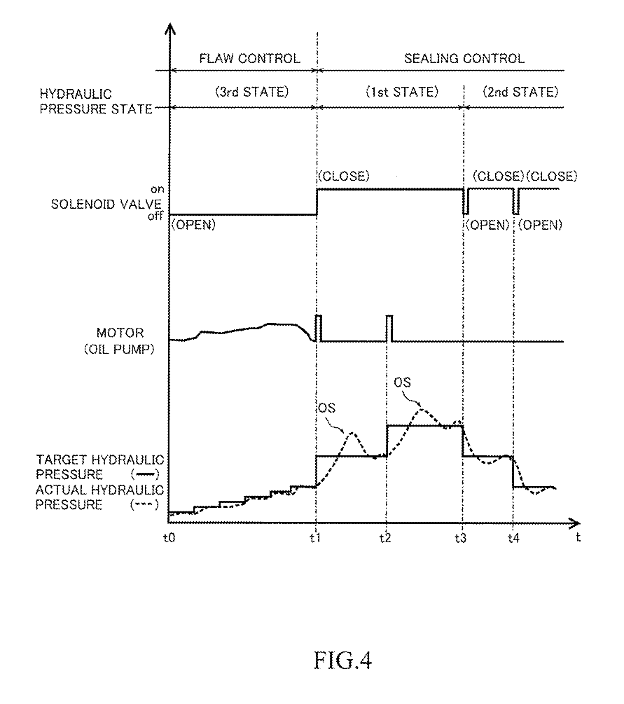

FIG. 4 is a time chart illustrating states before and after a general sealing control using the solenoid valve 43 and the motor 37. In this figure, the horizontal and vertical axes respectively show time and signal intensity (namely, amplitude). And the upper, middle and lower sections respectively represent opening and closing states of the solenoid valve 43, drive commands of the motor 37, and command hydraulic pressures of the piston chamber 15 in solid line and actual pressures in dashed line. This applies to descriptions below.

On one hand, in the state from time t0 to t1 when supplying a hydraulic pressure to the piston chamber 15 in a range where the above-mentioned command torque is a predetermined torque or lower (namely, in a predetermined low torque range), the ECU 50 performs control so that the piston chamber 15 reaches a target hydraulic pressure on the basis of the above-described third state. In this third state, as the solenoid valve 43 is opened all the time, the hydraulic pressure control for the piston chamber 15 is performed as the flow control (namely, non-sealing control) using the motor 37. In this manner, in the low torque range, the flow control is performed to a hydraulic pressure supplied to the piston chamber 15.

On the other hand, in the state from time t1 to t3 when pressurizing the piston chamber 15 in a torque range higher than the above-described low torque range, the ECU 50 performs control so that the piston chamber 15 reaches the target hydraulic pressure (namely, sealing control) on the basis on the above-described first state. In this first state, as the solenoid valve 43 is closed all the time, the hydraulic fluid is sealed in the oil passage 49. Thus, in this state, the hydraulic pressure control for the piston chamber 15 is performed as hydraulic pressure sealing pressurization control by a step-by-step (namely, intermittent) drive of the oil pump 35 using the motor 37.

By maintaining the state in which the hydraulic fluid is sealed in the oil passage 49 before starting decompression after pressurizing until the piston chamber 15 reaches the target hydraulic pressure on the basis of the first state, the torque of the power transmission clutch 10 can be kept constant without driving the oil pump 35.

Further, in the state from time t3 to t4 when decompressing the piston chamber 15, the ECU 50 performs control so that the piston chamber 15 reaches the target hydraulic pressure on the basis of the above-described second state. In this case, using the motor 37 but without driving the oil pump 35, the piston chamber 15 is decompressed by opening the solenoid valve 43 intermittently.

In this manner, in the torque range higher than the above-described low torque range, the operation of the motor 37 of the oil pump 35 can be reduced in frequency by performing the hydraulic pressure control of the piston chamber 15 as the sealing control. This can improve durability.

FIG. 4 also illustrates overshoots OS in a general control. That is to say, as shown in FIG. 4, while the piston chamber 15 is in the first state t1 to t3, an actual hydraulic pressure largely exceeds a target hydraulicpressure, (which is referred to as “overshoot OS”), after driving the motor 37. Such a large overshoot OS might make sealing control unstable. In order to prevent this instability, the ECU 50 in the present embodiment performs control as follows.

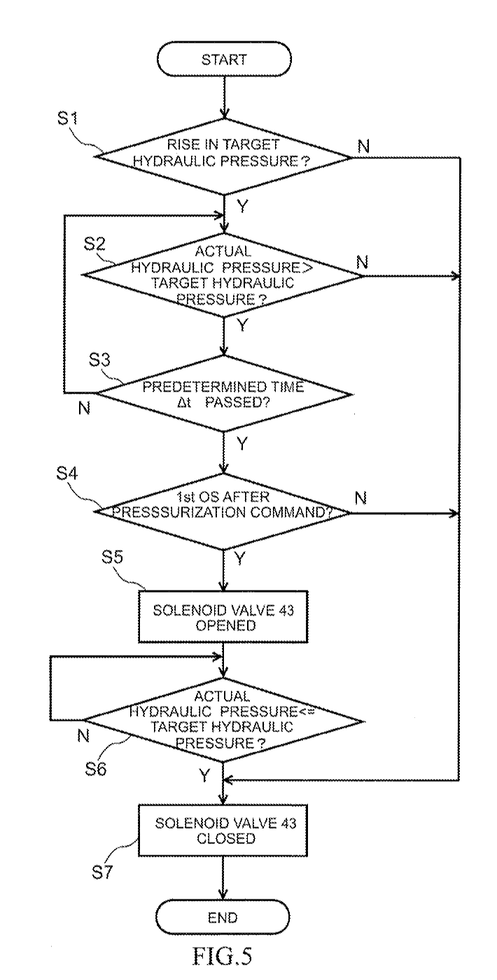

FIG. 5 a flow chart describing opening control of the solenoid valve 43 when regulating pressure while continuing the sealing control in the present embodiment. The control described in FIG. 5 is performed by the ECU 50. First, as described above, the piston chamber 15 is in the first state when performing the sealing control. Namely, the solenoid valve 43 is closed, whereby the oil pump 35 can be driven. In this state, when the ECU 50 receives a signal of increase in the target hydraulic pressure by a predetermined amount, a pressure increase judgment of the oil pump 35 is made to judge whether the target hydraulic pressure has increased (Step S1).

In Step S1, if a signal of an increase in target hydraulic pressure, namely, a pressurization command is received, the pressure in the piston chamber 15 rises afterwards. Here, in the sealing control, as described above, the actual hydraulic pressure may rise higher than the target hydraulic pressure (Step S2).

In Step 2, if the actual hydraulic pressure exceeds the target hydraulic pressure, the pressure might rise more than necessary. In this case, whether the actual hydraulic pressure is continuously over the predetermined hydraulic pressure (namely, “actual hydraulic pressure>designated hydraulic pressure”) during a predetermined time Δt (namely, whether a predetermined condition has been fulfilled) is judged.

In Step 3, If this duration time becomes the predetermined time Δt or longer, the actual hydraulic pressure is judged to be in the state of overshoot OS, namely, to be a hydraulic pressure higher than necessary compared to the target hydraulic pressure. Here, at the same time, how many times the overshoot OS has occurred after the above-described pressurization command is counted, and whether this overshoot OS is the first one is judged (Step S4).

In Step 4, if the overshoot OS is not the first one, namely, if the overshoot OS is the second or later one, the solenoid valve 43 is left closed. This is because if the first overshoot occurs to the hydraulic pressure of the piston chamber 15, the overshoot amount is sufficiently restrained by opening the solenoid valve 43 in many cases.

In Step 4, if the overshoot is judged to be the first one, the solenoid valve 43 is opened (Step S5). In this case, the piston chamber 15 transfers temporarily from the first state to the second state (namely, state switching control is performed).

After the solenoid valve 43 is opened in Step S5, whether the actual hydraulic pressure has returned to the target hydraulic pressure (namely, whether “actual hydraulic pressure<=target, hydraulic pressure” is achieved) is judged (Step S6). Here, the actual hydraulic pressure becomes the designated hydraulic pressure or less, the solenoid valve 43 is again closed (Step S7). Accordingly, the piston chamber 15 returns to the first state again (namely, state second-time switching control is performed).

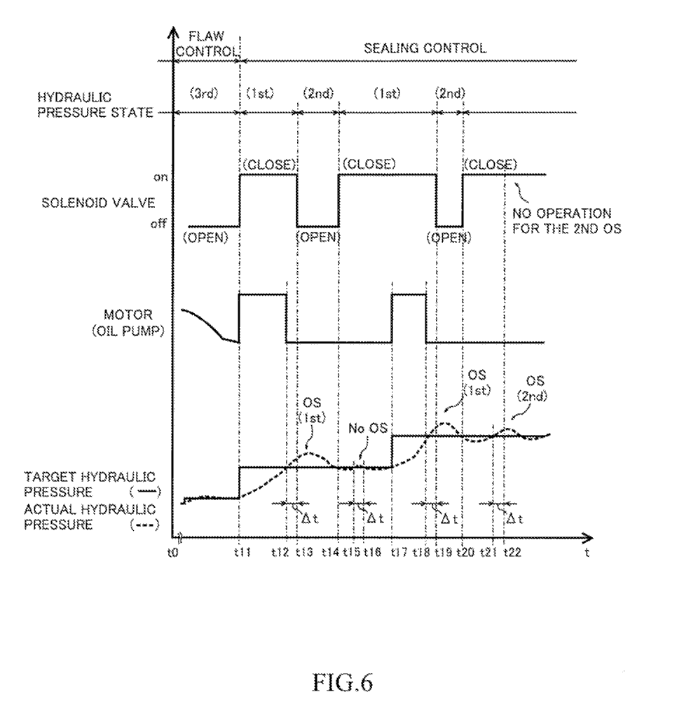

FIG. 6 is a time chart describing states before and after the sealing control of the present embodiment using the solenoid valve 43 and the motor 37. The same figure describes the opening and closing control of the solenoid valve 43 of the above-described present embodiment, illustrating a case in which pressure regulation is performed two times while the sealing control continues.

At time t11 when transferring from the flow control (namely, non-sealing control) to the sealing control, the hydraulic pressure state of the piston chamber 15 transfers from the third state to the first state. As the target hydraulic pressure rises here, the oil pump 35 is driven by the motor 37 while the solenoid valve 43 is closed. Then, the actual hydraulic pressure rises and thus reaches the target hydraulic pressure at time t12. Here, the motor 37 stops driving.

Even if the motor 37 stops driving at time t12, the actual hydraulic pressure continues rising tor a while and accordingly exceeds the target hydraulic pressure. Here, in the present embodiment, the overshoot OS is not determined immediately, but it is judged whether the actual hydraulic pressure has continued exceeding the designated hydraulic pressure during a predetermined time Δt. Then, if the actual hydraulic pressure is beyond the designated hydraulic pressure still at time t13 when the predetermined time Δt has passed, the overshoot OS is determined.

The overshoot OS at time t13 is the first one after the increase in the target hydraulic pressure. Therefore, the solenoid valve 43 is turned off to be opened. This causes a decrease in the hydraulic pressure of the sealed oil passage. Consequently, a positive decrease in the actual hydraulic pressure is effected to reduce the overshoot OS amount.

At time t14 when the actual hydraulic pressure becomes the target hydraulic pressure or less, the solenoid valve 43 is closed, thereby terminating the positive decrease in the hydraulic pressure dining the sealing control.

At time t15, the actual hydraulic pressure is beyond the target hydraulic pressure. Then, it is judged whether the overshoot OS has occurred again. And, in the present embodiment, as the actual hydraulic pressure is the target hydraulic pressure or less at time t16 when a predetermined time Δt has passed, the overshoot OS is not determined, and accordingly no command is given to the solenoid valve 43 and the motor 37.

At time t17 when the target hydraulic pressure rises during the sealing control, the motor 37 is driven. Then, the actual hydraulic pressure rises. And then, at time t18, the actual hydraulic pressure reaches the target hydraulic pressure. Here, the motor 37 stops driving.

As the actual hydraulic pressure is beyond the target hydraulic pressure time t18, it is judged whether this state (namely, the state of “actual hydraulic pressure>target hydraulic pressure”) has continued during a predetermined time Δt. And upon confirmation of the first overshot OS at a time t19 when the predetermined time Δt has passed, the solenoid valve 43 is opened. And, at time t20 when the actual hydraulic pressure becomes the target hydraulic pressure or less, the solenoid valve 43 is closed.

As the actual hydraulic pressure is again beyond the target hydraulic pressure at time t21, it is determined whether this state (namely, the state of “actual hydraulic pressure>target hydraulic pressure”) has continued dining a predetermined time Δt. At time t22 when the predetermined time Δt has passed, the actual hydraulic pressure is still beyond the target hydraulic pressure. Therefore, at this time, the overshoot OS has occurred. However, this overshoot OS is the second one after time t17 when the target hydraulic pressure was controlled to rise last time. Therefore, the solenoid valve 43 is left closed without being opened.

As described above, in the vehicle control device of the present embodiment, if the actual hydraulic pressure exceeds the target hydraulic pressure when the piston chamber 15 is in the first state, the ECU 50 performs the state switching control that switches the first state to the second state. Since the hydraulic chamber 15 is decompressed during the sealing control in the second state, the actual hydraulic pressure can be prevented from largely exceeding the target hydraulic pressure. This enables accurate control while taking an advantage of the hydraulic pressure sealing-type control.

Furthermore, the ECU 50 may characteristically perform the state switching control when the actual hydraulic pressure fulfils a predetermined condition beyond the target hydraulic pressure. The predetermined condition in the present embodiment is the duration time for which, or longer than which, the target hydraulic pressure is beyond the actual hydraulic pressure or higher (namely, predetermined time Δt). This can prevent excessively frequent performance of the state switching control when the actual hydraulic pressure frequently exceeds and falls below the target hydraulic pressure, and thus ensures stability and accuracy of the control.

Moreover, when performing the state switching control if the actual hydraulic pressure exceeds the target hydraulic pressure, the ECU 50 switches the oil pump 35 and the motor 37 to the non-pressure rising state before switching the solenoid valve 43 to the non-holding state. In this manner, by switching the oil pump 35 and the motor 37 and switching the solenoid valve 43 at different timings, the control can be performed clearly and accordingly accurately.

Furthermore, the ECU 50 performs the state switching control only once every time when the target hydraulic pressure rises by a predetermined amount. This state switching control decompresses the inside of the hydraulic chamber (15). Thus, by limiting the number of times of the state switching control, excessive reduction in the hydraulic pressure of the piston chamber 15 in which the hydraulic pressure is sealed can be prevented.

Also, if the actual hydraulic pressure fails below the target hydraulic pressure after performing the state switching control due to the actual hydraulic pressure exceeding the target hydraulic pressure, the ECU 50 may perform state second-time switching control that switches the second state to the first state. In this manner, by performing the state second-time switching control when the actual hydraulic pressure again reaches the target hydraulic pressure, a next increase in the target hydraulic pressure can be immediately coped with.

While one embodiment of the present invention has been described above, the invention is not limited to the above-mentioned embodiment but various modifications are possible within the scope of the technical idea as defined in the claims, the specification, and the drawings.

For example, in FIG. 2, the solenoid valve 43 is disposed directly in the oil passage 49 between the oil pump 35 and the piston chamber 15. However, the configuration of the present invention is not limited to this. For example, an oil passage may be formed on the opposite side of the oil passage 49 with respect to the piston chamber 15, and the solenoid valve 43 may be disposed in this oil passage.

Further, the piston chamber 15 may be configured to communicate to an accumulator. The accumulator has an effect of suppressing a sudden change in hydraulic pressure and a hydraulic pulsation in the piston chamber 15 and the oil passage 49. It should be noted that instead of the check valve 39 used in the present embodiment as a hydraulic fluid sealing valve for sealing the oil passage 49 at the time of switching from pressurization to pressure holding, an ON/OFF-type solenoid valve may be used. In this case, the accumulator can be omitted.

Moreover, in the above-described embodiment, the predetermined condition for switching the first state to the second state is the duration time for which, or longer than which, the target hydraulic pressure is beyond the actual hydraulic pressure or higher (namely, predetermined time Δt). However, the present invention is not limited to this. For example, the predetermined condition may be a predetermined differential pressure between an actual hydraulic pressure and an target hydraulic pressure.

Moreover, in the above-described embodiment, the second state, which is a state of a hydraulic pressure applied to the piston chamber 15 by the hydraulic circuit 30, is specified as stopping driving the oil pump 35 and opening the solenoid valve 43. However, the present invention is not limited to this. The second state may be a state in which the piston chamber 15 is decompressed by opening the solenoid valve 43 regardless of driving of the oil pump 35.

1-6. (canceled)

7. A vehicle control device comprising:
a power transmission mechanism having a power transmission element and a hydraulic chamber into which a hydraulic pressure operating the power transmission element is introduced, the power transmission mechanism arranged in a power transmission path transmitting power from a power source to driving wheels;
a first pressure regulating mechanism switching a pressure rising state and a non-pressure rising state of a hydraulic pressure of the hydraulic chamber;
a second pressure regulating mechanism switching a holding state and a non-holding state of a hydraulic pressure of the hydraulic chamber; and
a control device controlling the first pressure regulating mechanism and the second pressure regulating mechanism so that an actual hydraulic pressure of the hydraulic chamber reaches a target hydraulic pressure,
wherein the control device can switch a first state in which the pressure regulating mechanism is in the pressure rising state and the second pressure regulating mechanism is in the holding state so as to increase pressure of the hydraulic chamber and a second state in which the second pressure regulating mechanism is in the non-holding state so as to decompress the hydraulic chamber, and
wherein the control device performs state switching control that switches the first state to the second state when the control device receives a signal of increase in the target hydraulic pressure and an overshoot that the actual hydraulic pressure largely exceeds the target hydraulic pressure occurs.

8. The vehicle control device according to claim 7 wherein the control device performs the state switching control when the actual hydraulic pressure fulfils a predetermined condition beyond the target hydraulic pressure.

9. The vehicle control device according to claim 8 wherein the predetermined condition is a duration time for which, or longer than which, the target hydraulic pressure is beyond the actual hydraulic pressure or higher.

10. The vehicle control device according to claim 7 wherein in the state switching control, the control device switches the first pressure regulating mechanism to the non-pressure rising state before switching the second pressure regulating mechanism to the non-holding state.

11. The vehicle control device according to claim 7 wherein the control device performs the state switching control only once every time when the target hydraulic pressure rises by a predetermined amount.

12. The vehicle control device according to claim 7 wherein if the actual hydraulic pressure falls below the target hydraulic pressure after performing the state switching control due to the actual hydraulic pressure exceeding the target hydraulic pressure, the control device performs a state second-time switching control switching the second state to the first state.

13. The vehicle control device according to claim 7 wherein the control device performs no state switching control that switches the first state to the second state when no overshoot occurs.
